(19) United States
(12) Patent Application Publication
(10) Pub. No.: US 2006/0294477 A1
(43) Pub. Date: Dec. 28, 2006

(54) Portable electronic device with the ability of directly inserting image data into a menu and its method

(75) Inventors: Chih-Chuan Cheng, Taipei (TW); Hong-Tien Wang, Taipei (TW); Wen-Sung Tsai, Taipei (TW); Tsai-Chung Wang, Taipei (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Compal Electronics, Inc.

(21) Appl. No.: 11/315,169

(22) Filed: Dec. 23, 2005

(30) Foreign Application Priority Data
Jun. 27, 2005 (TW) 094121391

(51) Int. Cl. G06F 9/00

(52) U.S. Cl. 715/810

(57) ABSTRACT

The present invention relates to a portable electronic device with the ability of directly inserting image data into a menu, which comprises: a display device, for displaying data; an image capturing device, coupled to the display device, for capturing image data; a memory device, for temporarily storing the image data; a controller, coupled to the image capturing device, display device and memory device; and a menu program, displayed on the display device; thereby, the display device will display a menu with a display screen and the image data captured by the image capturing device will be directly inserted into the display screen when the menu program is executed. Furthermore, the present invention also provides a method for directly inserting image data into a menu.

### BACKGROUND OF THE INVENTION

1 Field of the Invention

The present invention relates to a portable electronic device capable of directly inserting image data into a menu and its method, and more particularly to a portable electronic device that uses an image capturing device to capture an external image data and then directly insert the image data into the portable electronic device, and its method.

2. Description of the Related Art

A prior art image capturing device usually inserts an image data into a menu by the following method: 1. Use an image capturing device to capture an external image data and save the image data. 2. Select the desired menu. 3. Select the stored image data and insert the image data into the desired menu. We found that the prior art method is commonly used in various different mobile phones having a camera function. After the mobile phone is used to take a picture and save the picture, the required linked personal data is selected in the directory, and a desired picture is selected for the insertion, and finally the instruction of inserting the picture is executed. However, such method has the following shortcomings: 1. It is necessary to search for the desired picture among many other pictures for using this indirect selection method, and thus causing the user to make a wrong selection easily; 2. Users must browse each picture before deciding to select the picture if this indirect method is used for selecting the pictures, and thus the design is not user-friendly. 3. The use of this indirect method is boring and not skillful.

R.O.C. Pat. No. 221725 entitled “Menu fixing structure and image identifying device having such structure” (filed on Jan. 16, 2003 and published on Oct. 1, 2004) comprises: an input section for inputting a media image, a pillar installed together with the input section, a support base for disposing a medium thereon, a fixing mechanism installed on the support base, and the fixing mechanism is used for fixing the medium and the medium fixing structure, and a medium fixing structure installed on the support base at the top of the fixing mechanism. Such patent primarily relates to a menu fixing structure of an image identifying device and an image identifying device having such structure, but it does not come with the function of directly inserting an image data into the menu.

### SUMMARY OF THE INVENTION

The primary objective of the present invention is to provide a portable electronic device for directly inserting an image data into a menu, so that it is not necessary for a user to select and avoid a wrong selection, if an image data captured by an image capturing device is inserted directly into a menu.

Another objective of the present invention is to provide a portable electronic device for directly inserting an image data into a menu, so that a user can take the picture to obtain a dynamic or a static image data and then directly insert the data into a menu. The design is user-friendly and convenient.

Another objective of the present invention is to provide a method for directly inserting an image data into a menu, so that the operating procedure can be simplified and the method is fresh to users.

To achieve the foregoing objectives of the present invention, a portable electronic device for directly inserting an image data into a menu in accordance with the present invention comprises a display device for displaying data; an image capturing device coupled to the display device for capturing an image data; and a controller coupled to the image capturing device and the display device for receiving a menu signal to determine a menu, and the menu includes a display window, and the controller automatically compares the image data capture by the image capturing device with the display window, and adjusts the pixel of the image data for inserting the image data into the display window.

To achieve the foregoing objectives, a method for directly inserting an image data into a menu comprises the steps of: The controller of a portable electronic device receiving a menu signal to determine a menu, and the menu includes a display window; using the portable electronic device to capture an image data; and the controller automatically comparing the image data and the display window to determine the pixel of the image data and insert the image data into the display window, so as to combine the menu and the image data.

### BRIEF DESCRIPTION OF THE DRAWINGS

FIG. 1 is a schematic block diagram of a portable electronic device for directly inserting an image data into a menu according to a preferred embodiment of the present invention;

FIG. 2 is a schematic view of a method for inserting an image data into a menu according to a preferred embodiment of the present invention;

FIG. 3 is a schematic view of a method for inserting an image data into a menu according to another preferred embodiment of the present invention; and

FIG. 4 is a flow chart of a method for inserting an image data into a menu according to a preferred embodiment of the present invention.

### DETAILED DESCRIPTION OF THE PREFERRED EMBODIMENTS

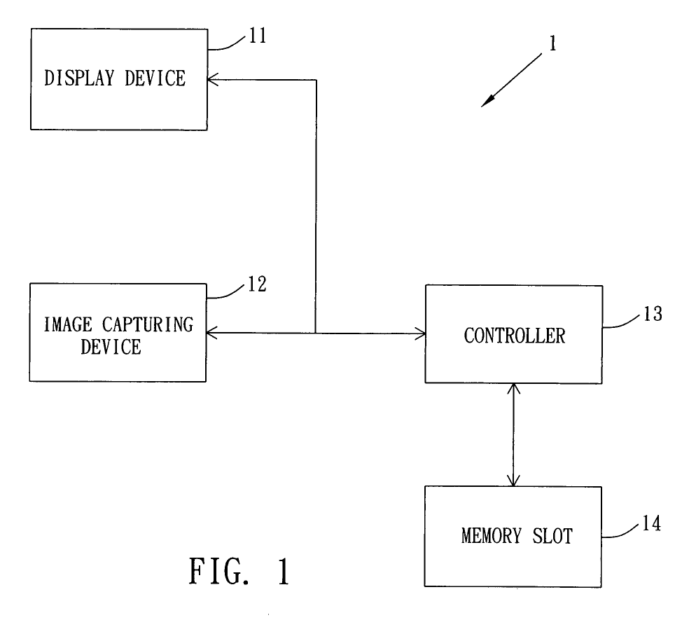

Referring to FIG. 1 for the schematic block diagram of a portable electronic device for directly inserting an image data into a menu according to a preferred embodiment of the present invention, the portable electronic device for directly inserting an image data into a menu 1 preferably a portable video player having a camera function, a personal digital assistant (PDA), or a mobile phone comprises: a display device 11; an image capturing device 12, and a controller 13.

The display device 11 including but not limited to a liquid crystal display (LCD) is provided for displaying data for a user's view, and the image capturing device 12 including but not limited to a CCD image capturing module, a CMOS image capturing module, or a digital camera module is coupled to the display device 11 for capturing an image data and displaying the image data on the display device 11.

The controller 13 is a core of the portable electronic device 1 and the controller 13 is coupled to the display device 11 and the image capturing device 12 for controlling the operation of the portable electronic device 1 of the present invention. If a user decides to a desired menu for inserting the image, then the controller 13 will receive a menu signal inputted by the user to determine a menu, wherein the menu includes a display window. After the user uses a portable electronic device 1 to take a picture or shoot a section of video images, the controller 13 will automatically compare the image data captured by the image capturing device 12 with a display window on the menu, and automatically adjust the size (or pixel) of the image data captured by the image capturing device 12 to the size (or pixel) of the display window and insert the captured image data into the display window of the menu to combine the menu and the image data.

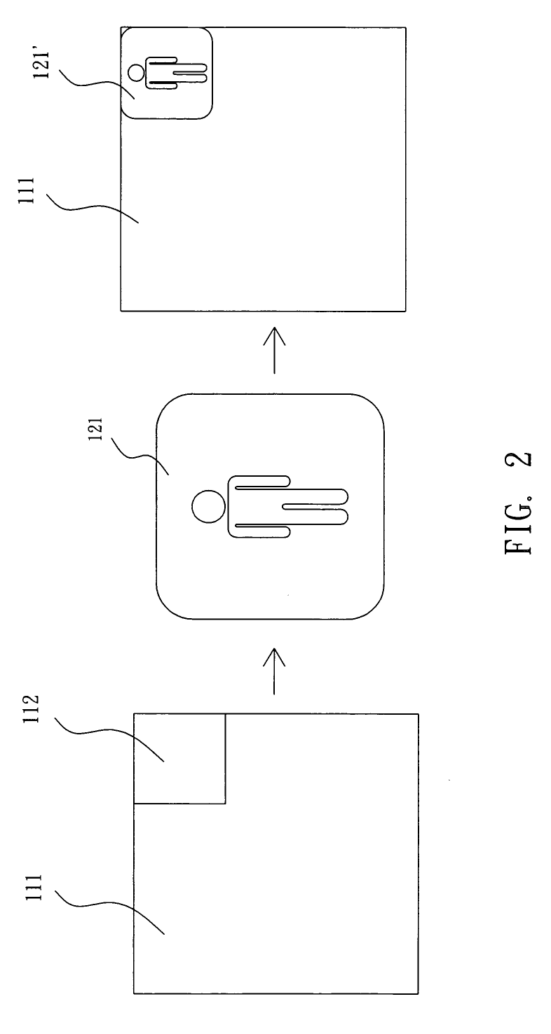

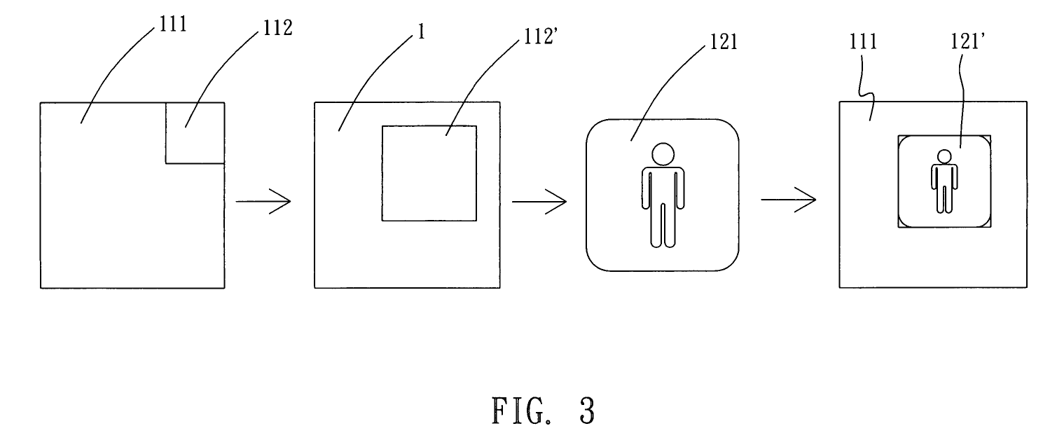

Refer to FIGS. 2 and 3 for further illustrations, and FIG. 2 is the schematic view of a method for inserting an image data into a menu according to a preferred embodiment of the present invention, and FIG. 3 is the schematic view of a method for inserting an image data into a menu according to another preferred embodiment of the present invention.

After a user decides a menu, the display device 11 will display a menu 111, and the menu 111 includes a display window 112, and the controller 13 inserts an image data 121 captured by an image capturing device 12 into a display window 112. The size and position of the display window 112 are fixed as shown in FIG. 2 or adjustable as shown in FIG. 3. The image capturing device 12 determines the pixel of the image data 121 according to the size of the display window 112, 112′, and the image data 12 is converted into an image data 121′ and the image data 121′ is linked with the display window 112 according to the coordinates of the display window 112, 112′, such that the image data 121′ is displayed in the display window 112, 112′. The way of adjusting the pixels of the image data 121 according to the size of the window 112, 112′ to determine the size of the image data 121 is a prior art, and thus will not described here.

If the image data 121 is a static photo, then the pixel of the image data 121 such as 320*240 or 640*480 will be determined to determine the size of the image data 121 and convert the image data 121 into an image data 121′, and then the coordinates of the display window 112, 112′ are used to link the image data 121′ with the display window 112, 112′, such that the image data 121 ′ is inserted into the display window 112, 112′ to combine a menu 111 and the image data 121′. If the image data 121′ is a dynamic movie (video), then the video can be played in the display window 112, 112′ because the video only plays several tens of photos per second to make it as a video. Therefore, determining the pixels of each photo can determine the size of the screen for playing the video, and the coordinates of the display window 112, 112′ are used to determine the position of the screen for playing the photos. Similarly, the video can be inserted into the display window 112, 112′ for playing the video, so as to combine the menu 111 and the video.

To improve the memory capacity of the portable electronic device 1, the present invention further includes a memory slot 14 for coupling the controller 13 to insert at least one memory card (not shown in the figure), wherein the memory including but not limited to a SmartMedia, a CompactFlash, a MMC, a Security Digital (SD), a Memory Stick, a Memory Stick Pro, a Xd or a Microdrive memory card. These memory cards are prior arts, and thus will not be described here.

With the foregoing structure, the portable electronic device 1 of the present invention can insert the image data 121 captured by the image capturing device 12 directly into the menu 111 without being selected by the user, and thus the present invention can avoid wrong selections. For example, when a mobile phone is used, the basic data of a directory is inputted, and then the mobile phone is used to take a photo or record a video. Now, the mobile phone will automatically combine the directory and the photo or video to complete the directory, so that a user no longer needs to select the desired picture or video among lots of other files, and thus the present invention surely can overcome the shortcomings of the prior art mobile phones and make the function of the mobile phones more diversified.

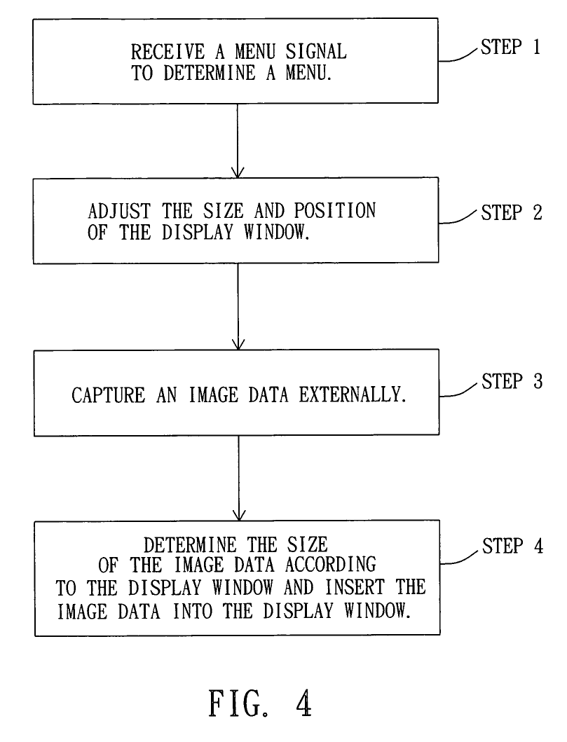

Referring to FIG. 4 for the flow chart of a method for inserting an image data into a menu according to a preferred embodiment of the present invention, the method is applied to a portable electronic device and comprises the following steps. In Step 1, A menu signal is received to determine a menu; a user selects a menu from a menu preinstalled in the portable electronic device, such that a controller of the portable electronic device receives a menu signal selected by the user to determine a menu and said menu includes a display window, and the menu is a personal information related table including a directory, an autobiography, or a resume.

In Step 2, the size and position of the display window are adjusted, the portable electronic device designs and adjusts the function of the display window, and thus the user can adjust the display window of the menu to an appropriate position in the menu and the display window to an appropriate size according to personal preferences.

In Step 3, an external image data is captured, and a user uses the portable electronic device to capture at least one image data from the outside. Of course, the image data could be a static image data such as a photo, or a dynamic image data such as a movie.

In Step 4, the size of the image data is determined according to the display window, and the image data is inserted into the display window, and the controller determines the size of an image data according to the size of the display window of the menu. If the image data is a static picture, then the pixel of the image data will be determined to determine the size of the image data, and the portable electronic device converts the captured image data according to the size of the display window into an image date that fits the size of the display window, and then the coordinates of the display window are used to link the converted image data with the display window, so as to insert the converted image data into the display window to combine the menu and the image data. Similarly, if the captured image data is a dynamic movie, the dynamic movie can be played in the display window because the dynamic movie continuously plays several tens of pictures per second to produce a dynamic movie. Therefore, determining the pixel of each picture can determine the size of screen for playing the movie, and the coordinates of the display window are used to determine the position of the screen for playing the pictures. Therefore, the menu and the dynamic movie can be combined and display in the display window.

The method for inserting an image data directly into a menu in accordance with the present invention uses a portable electronic device to capture an image data from the outside, and directly combines the image data and the menu to display them in the display window. Thus, the present invention surely can overcome the shortcomings of the prior art that selects the image data directly and inserts the data in the menu inconveniently.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A portable electronic device for directly inserting an image data into a menu, comprising:
a display device, for displaying data;
an image capturing device, coupled to said display device for capturing an image data; and
a controller, coupled to said image capturing device and said display device for receiving a menu signal to determine a menu, and said menu includes a display window, and said controller automatically compares said image data captured by said image capturing device with said display window and adjust the pixel of said image data, so as to insert said image data into said display window.

2. The portable electronic device for directly inserting an image data into a menu of claim 1, wherein said portable electronic device is a portable video player having a camera function or a personal digital assistant (PDA).

3. The portable electronic device for directly inserting an image data into a menu of claim 1, wherein said image capturing device is a CCD image capturing module, a CMOS image capturing module, or a digital camera module.

4. The portable electronic device for directly inserting an image data into a menu of claim 1 further comprising a memory slot coupled to said controller for inserting at least one memory card.

5. The portable electronic device for directly inserting an image data into a menu of claim 4, wherein said memory card is a SmartMedia, a CompactFlash, a MMC, a Security Digital (SD), a Memory Stick, a Memory Stick Pro, a Xd, or a Microdrive memory card.

6. The portable electronic device for directly inserting an image data into a menu of claim 1, wherein said image data is a static image data.

7. The portable electronic device for directly inserting an image data into a menu of claim 1, wherein said image data is a dynamic image data.

8. The portable electronic device for directly inserting an image data into a menu of claim 1, wherein said display window has adjustable size and position.

9. A method for directly inserting an image data into a menu, being applied to a portable electronic device, and comprising the steps of:
a controller of said portable electronic device receiving a menu signal to determine a menu, and said menu includes a display window;
using an image capturing device of said portable electronic device to capture an image data; and
said controller automatically comparing said image data with said display window to determine the pixel of said image data pixel, and inserting said image data into said display window, so as to combine said menu and said image data.

10. The method for directly inserting an image data into a menu of claim 9, wherein said portable electronic device is a portable video player having a camera function or a personal digital assistant (PDA).

11. The method for directly inserting an image data into a menu of claim 9, wherein said image data is a static image data.

12. The method for directly inserting an image data into a menu of claim 9, wherein said image data is a dynamic image data.

13. The method for directly inserting an image data into a menu of claim 9, wherein said step of said portable electronic device selecting a menu and said menu including a display window further comprises a step of adjusting the size and position of said display window for adjusting the size and position of said display window.

14. The method for directly inserting an image data into a menu of claim 13, wherein said step of adjusting the size and position of said display window includes said portable electronic device determining the pixel of said image data according to the size of said display window to determine, and using the coordinates of said display window to link said image data with said display window, so as to display said image data on said display window.
